(19) United States
(12) Patent Application Publication
(10) Pub. No.: US 2006/0170727 A1
(43) Pub. Date: Aug. 3, 2006

(54) Inkjet recording device and method for cleaning nozzle face of inkjet recording head

(75) Inventors: Atsumichi Imazeki, Kanagawa (JP); Kishiharu Itazu, Kanagawa (JP); Hiroshi Ikeda, Kanagawa (JP); Kohei Murakami, Kanagawa (JP); Masashi Hiratsuka, Kanagawa (JP); Atsushi Murakami, Kanagawa (JP); Katsushi Amarume, Kanagawa (JP); Takaaki Sekiyama, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/179,326

(22) Filed: Jul. 12, 2005

(30) Foreign Application Priority Data
Feb. 2, 2005 (JP) 2005-26398

(51) Int. Cl. B41J 2/165

(52) U.S. Cl. 347/33

(57) ABSTRACT

An inkjet recording device of the present invention includes an inkjet recording head, a first wiper, a first movement component and a control component. The inkjet recording head ejects ink droplets from a plurality of nozzles formed in a nozzle face. The first wiper abuts against the nozzle face and wipes the nozzle face. The first movement component relatively moves the first wiper, with respect to the nozzle face, along the nozzle face. The control component controls ejection of ink droplets from the nozzles and controls the first movement component. The control component moves the first wiper relative to the nozzle face while the control component causes ink droplets to be ejected from the nozzles at least toward the first wiper, causing the nozzle face to be wiped.

### CROSS-REFERENCE TO RELATED APPLICATION

This application claims priority under 35 USC 119 from Japanese Patent Application No. 2005-026398, the disclosure of which is incorporated by reference herein.

### BACKGROUND OF THE INVENTION

1. Field of the Invention

The present invention relates to an inkjet recording device and a method for cleaning a nozzle face of an inkjet recording head.

2. Description of the Related Art

At an inkjet recording head, when ink adheres around nozzles of a nozzle face due to ink-misting during printing and the like, water-repellence falls, directions of discharge of ink droplets become unreliable, and image quality deteriorates. Accordingly, the nozzle face is wiped (swept) at predetermined times with a resilient blade, to clean the nozzle face.

However, if ink stays adhered to the nozzle face for a long time, and thickens and solidifies, the ink cannot be removed simply by wiping (sweeping), and wiping smears and ink residues will result. This occurs particularly noticeably with pigment inks which are high in water-resistance.

If a force with which the resilient blade is abutted against the nozzle face is strengthened in order to remove such thickened/solidified ink, a water-repellence treatment layer of the nozzle face will be damaged and/or detached.

Therefore, in order to remove thickened/solidified ink, it is desirable to perform wiping (sweeping) with the resilient blade after wetting and liquefying the thickened/solidified ink.

For example, a method has been proposed in which a suction operation is performed and thickened/solidified ink is wetted and liquefied, after which a nozzle face is wiped (swept) with a resilient blade. (See, for example, Japanese Patent Application Laid-Open (JP-A) Nos. 8-39830 and 9-58015.)

However, because this suction operation is performed each time the nozzle face is wiped (swept) with the resilient blade, operations are complex and time-consuming. Furthermore, an amount of ink which is wastefully consumed (i.e., ink which is discarded without being applied to image formation) is increased.

As a further example, a method has been proposed in which ink droplets are discharged at a first wiper, which is formed of a sponge, for dampening the first wiper and a nozzle face is wiped (swept) with this first wiper for wetting and liquefying thickened/solidified ink, after which the nozzle face is wiped (swept) with a second wiper. (See, for example, JP-A No. 6-965.)

However, with this method, it is necessary to suction the ink with which the first wiper formed of sponge is dampened, with a suction pump, and clean away the ink. Therefore, operations are again complex and time-consuming. Moreover, because it is necessary to provide a suction pump or the like, an apparatus is more complicated and costs are higher.

### SUMMARY OF THE INVENTION

The present invention has been devised in view of the above circumstances and provides an inkjet recording device and a method for cleaning a nozzle face of an inkjet recording head.

An inkjet recording device of a first aspect of the present invention includes: an inkjet recording head, which ejects ink droplets from a plurality of nozzles formed in a nozzle face; a first wiper, which abuts against the nozzle face and wipes the nozzle face; a first movement component, which relatively, with respect to the nozzle face, moves the first wiper along the nozzle face; and a control component, which controls ejection of ink droplets from the nozzles and controls the first movement component, the control component moving the first wiper relative to the nozzle face while causing ink droplets to be ejected from the nozzles toward at least the first wiper, for wiping the nozzle face.

The inkjet recording device of the present invention ejects ink droplets from the nozzles toward at least the first wiper. While the first wiper is being moistened with ink, the first wiper wipes (sweeps) the nozzle face.

Thus, thickened/solidified ink which has adhered to the nozzle face of the inkjet recording head is wiped (swept) while being wetted and liquefied. Therefore, the thickened/solidified ink is easily removed from the nozzle face and cleaned off.

In a method for cleaning a nozzle face of an inkjet recording head of an inkjet recording device of a second aspect of the present invention, the inkjet recording device includes an inkjet recording head, which ejects ink droplets from a plurality of nozzles formed in a nozzle face, a wiper, which abuts against the nozzle face and wipes the nozzle face, and a first movement component, which relatively, with respect to the nozzle face, moves the first wiper along the nozzle face, and the cleaning method includes a step of cleaning, which includes: ejecting ink droplets from the nozzles toward at least the wiper; while ejecting the ink droplets, moving the wiper relative to the nozzle face; and wiping the nozzle face.

According to the present invention as described above, a nozzle face is wiped (swept) while a wiper is being moistened with ink. Thus, thickened and solidified ink which has adhered to the nozzle face of an inkjet recording head is wetted and liquefied while being wiped (swept), and the thickened/solidified ink can be simply removed and cleaned off from the nozzle face.

### BRIEF DESCRIPTION OF THE DRAWINGS

Preferred embodiments of the present invention will be described in detail based on the following figures, wherein:

FIG. 1 is a general view schematically showing a state of an inkjet recording device of a first aspect at a time of image recording;

FIG. 2 is a general view schematically showing a state of the inkjet recording device of the first aspect at a time of maintenance;

FIGS. 3A to 3C are views showing states when a wiping apparatus moves and wipes a nozzle face of an inkjet recording head, in a sequence from FIG. 3A to FIG. 3C.

FIG. 4A is a diagram schematically showing a sectional view of the wiping apparatus;

FIG. 4B is a view during wiping;

FIG. 4C is an enlarged view of a root portion of a resilient blade of FIG. 4B;

FIGS. 5A to 5D are views showing states when the wiping apparatus moves and wipes the nozzle face of the inkjet recording head under another control process, in a sequence from FIG. 5A to FIG. 5D;

FIGS. 6A and 6B are a flowchart of the other control process;

FIGS. 7A to 7C are views illustrating pre-control, in a sequence from FIG. 7A to FIG. 7C;

FIGS. 8A to 8C are views illustrating post-control, in a sequence from FIG. 8A to FIG. 8C;

FIG. 9A is a diagram schematically showing a sectional view of a wiping apparatus of a first variant example;

FIG. 9B is a view of the first variant example during wiping;

FIG. 10 is a sectional view schematically showing a wiping apparatus of a second variant example;

FIG. 11A is a perspective view, viewed from a downstream side, of an ink displacement member of the wiping apparatus of the second variant example;

FIG. 11B is a perspective view, viewed from an upstream side, of the ink displacement member of the wiping apparatus of the second variant example;

FIG. 12 is a sectional view schematically showing a wiping apparatus of a third variant example;

FIG. 13A is a diagram schematically showing a sectional view of a wiping apparatus of a fourth variant example;

FIG. 13B is a view of the fourth variant example during wiping; and

FIGS. 14A to 14C are views showing states when a nozzle face of an inkjet recording head of an inkjet recording device of a second embodiment is wiped, in a sequence from FIG. 14A to FIG. 14C.

### DETAILED DESCRIPTION OF THE INVENTION

Herebelow, embodiments of the present invention will be described with reference to the drawings.

First, an inkjet recording device 12 of a first embodiment will be described.

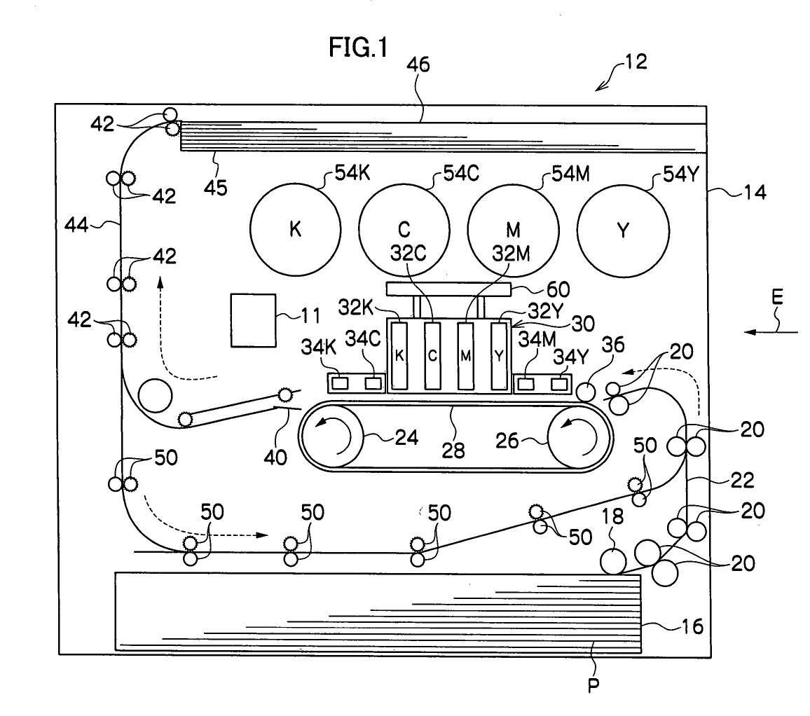

As is shown in FIG. 1, the inkjet recording device 12 is equipped with a control section 11. The control section 11 is responsible for each of various controls of the overall inkjet recording device 12.

A paper supply tray 16 is provided at a lower portion of the interior of a casing 14 of the inkjet recording device 12. Paper P which is stacked in the paper supply tray 16 can be taken out one sheet at a time by a pickup roller 18. The paper P that has been taken out is conveyed by conveyance roller pairs 20, which structure a predetermined conveyance path 22.

Upward of the paper supply tray 16, an endless-type conveyance belt 28 is provided spanning between a driving roller 24 and a driven roller 26. A recording head array 30 is arranged above the conveyance belt 28. The recording head array 30 opposes a flat region 28F of the conveyance belt 28. This opposition region constitutes an ejection region at which ink droplets are ejected from the recording head array 30. Paper P that is conveyed along the conveyance path 22 is retained at the conveyance belt 28 and brought to this discharge region, to oppose the recording head array 30. In this state, ink droplets are adhered to the paper P from the recording head array 30 in accordance with image information.

A separation plate 40 is disposed at a downstream side of the driving roller 24. The separation plate 40 separates the paper P from the conveyance belt 28. The separated paper P is conveyed by a plurality of ejection roller pairs 42, which structure an ejection path 44 at a downstream side of the separation plate 40, and is ejected to an ejection tray 46, which is provided at an upper portion of the casing 14.

In the present embodiment, an effective recording region of the recording head array 30 has a long narrow form with a width (i.e., a length in a direction intersecting the conveyance direction) at least as wide as the paper P. The recording head array 30 is provided with four inkjet recording heads 32Y, 32M, 32C and 32K arranged along the conveyance direction, corresponding to the four colors yellow (Y), magenta (M), cyan (C) and black (K), respectively. Thus, the recording head array 30 is capable of recording full-color images. That is, the recording head array 30 is a “full width array” (FWA) corresponding to the width of the paper. Herebelow, for other members too, where it is necessary to distinguish between Y, M, C and K, one of “Y”, “M”, “C” and “K” will be appended to a reference numeral, and where it is not necessary to distinguish between Y, M, C and K, “Y”, “M”, “C” and “K” will be omitted.

The inkjet recording heads 32 are not particularly limited in regard to a method of discharging ink droplets. Known processes can be employed, such as a “thermal” system, a “piezoelectric” system or the like.

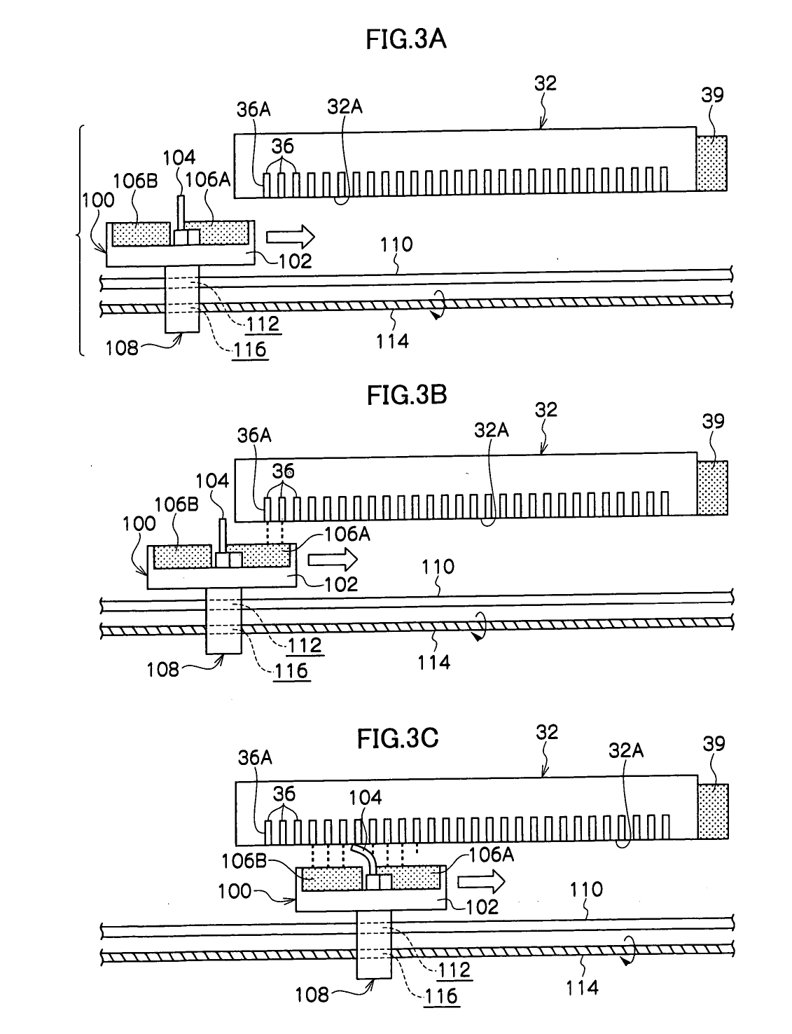

As shown in FIG. 3A, at each inkjet recording head 32, ink droplets are discharged from a plurality of nozzles 36, which are formed in a nozzle face 32A. A water-repellence layer is formed at a surface of this nozzle face 32A. Consequently, wetting of ink at portions circumferential to the nozzles 36 is uniform, and discharge characteristics of the ink droplets (discharge directions of the ink droplets, ink droplet diameters, ink droplet speeds and the like) are stable.

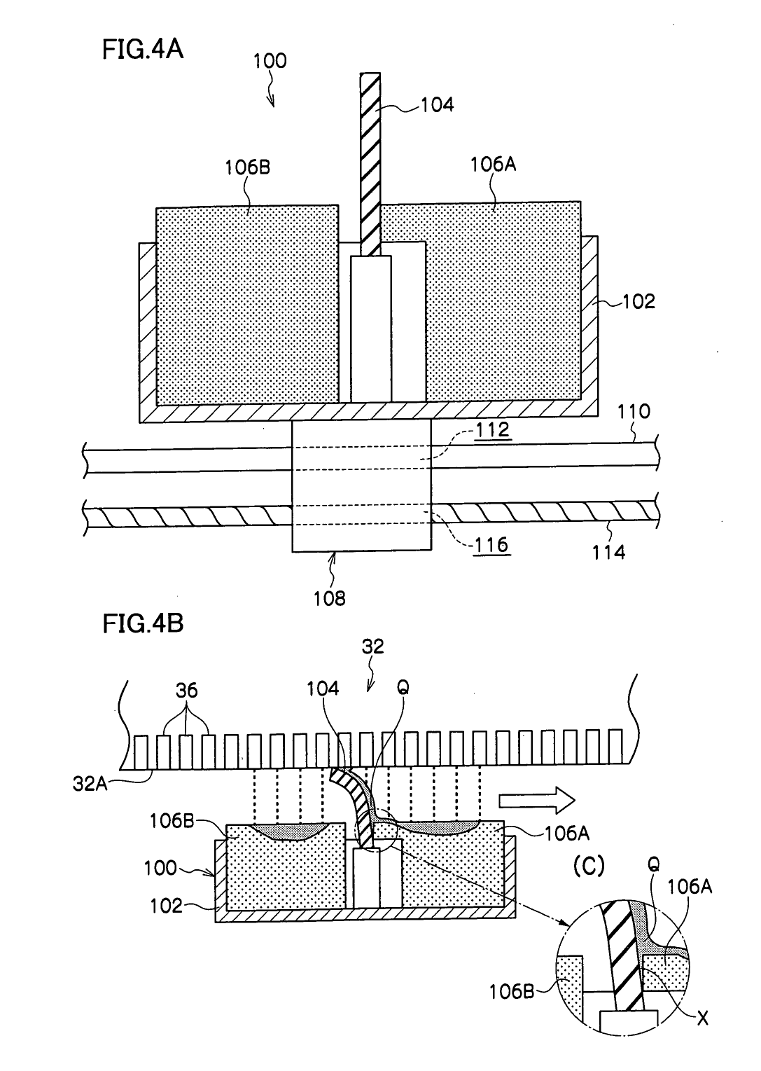

As shown in FIG. 1, four maintenance units 34Y, 34M, 34C and 34K, corresponding to the inkjet recording heads 32Y, 32M, 32C and 32K, are arranged at an upstream side and a downstream side relative to the recording head array 30. Each maintenance unit 34 is structured with a cap, a suction pump, a dummy jet receiver, a wiping apparatus 100 (see FIG. 4A) and the like, and carries out maintenance operations such as a suction-recovery operation, a dummy jet operation, a cleaning operation and the like.

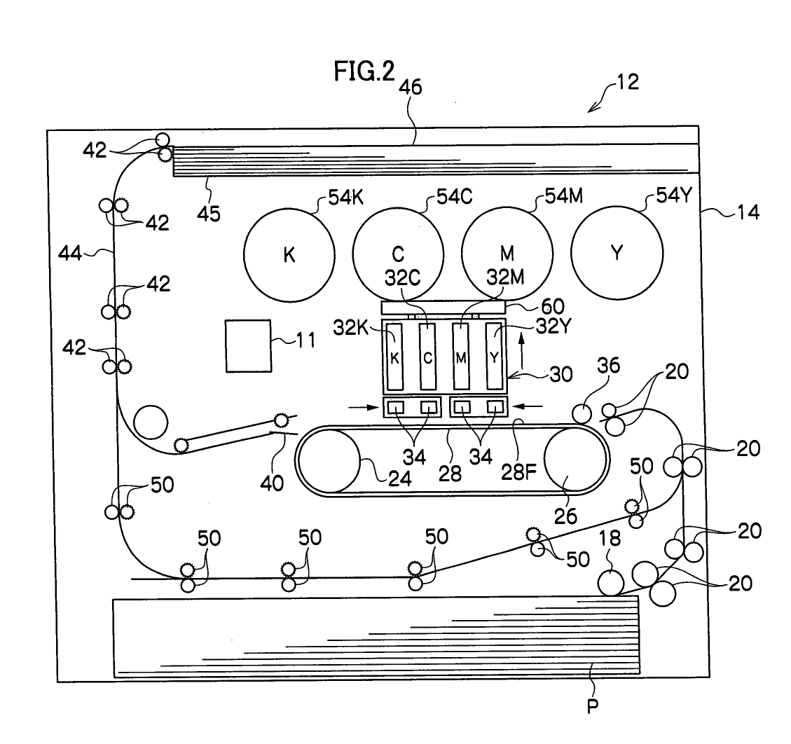

Hence, when maintenance is to be carried out on the inkjet recording heads 32, as shown in FIG. 2, the recording head array 30 is moved upward by a head movement mechanism 60, and the maintenance units 34Y, 34M, 34C and 34K are moved into a gap which is formed between the recording head array 30 and the conveyance belt 28. Then, in a state in which the maintenance units 34 oppose the inkjet recording heads 32 (see FIG. 3A), a predetermined maintenance operation is performed.

Next, the wiping apparatus 100 will be described.

As shown in FIGS. 4A to 4C, the wiping apparatus 100 is equipped with a box-like casing 102, whose upper end is open. A resilient blade 104, which is formed of urethane rubber or the like, is provided standing at a central portion of the casing 102. Ink absorbers 106A and 106B are provided at two opposite sides of the resilient blade 104.

A movement mechanism portion 108 is provided at a lower portion of the casing 102. This movement mechanism portion 108 is formed with a through-hole 112 and a through-hole 116. Here, a screw cutting is formed at an inner peripheral face of the through-hole 116.

A shaft 110 passes through the through-hole 112. A screw shaft 114 passes through the through-hole 116 and screwingly engages with the thread of the through-hole 116. The shaft 110 and the screw shaft 114 are fixed to a device casing, with the screw shaft 114 being rotatably fixed. The movement mechanism portion 108, the shaft 110 and the screw shaft 114 are not shown in the drawings other than FIGS. 3A to 3C and FIGS. 4A to 4C.

As shown in FIGS. 3A to 3C, when the screw shaft 114 is rotated by a motor or the like, the wiping apparatus 100 moves.

After the maintenance unit 34 has been put into the state of opposing the nozzle face 32A of the inkjet recording head 32 as shown in FIG. 2, the resilient blade 104 is lowered by the head movement mechanism 60 (see FIG. 1) to a position at which the resilient blade 104 abuts against the nozzle face 32A of the inkjet recording head 32, as shown in FIG. 3A. The screw shaft 114 is rotated and, as shown in FIGS. 3A to 3C, the wiping apparatus 100 moves along the nozzle face 32A and wipes (sweeps) the nozzle face 32A with the resilient blade 104. A speed of wiping (sweeping) (i.e., a speed of movement of the resilient blade 104) is 50 mm/s to 300 mm/s.

FIGS. 3A to 3C are views seen in the direction of arrow E of FIG. 1, and a length direction of the shaft 110 and the screw shaft 114 is a direction from a front side to a rear side of FIG. 1. Similarly, a direction of movement of the wiping apparatus 100 is the direction from front to rear of FIG. 1. Accordingly, the aforementioned ink absorbers 106A and 106B are structured to be disposed at an upstream side and a downstream side relative to the resilient blade 104 with respect to the movement direction of the wiping apparatus 100.

As shown in FIGS. 3A to 3C, while the nozzle face 32A of the inkjet recording head 32 is being swept with the resilient blade 104, the control section 11 (see FIG. 1) causes ink droplets to be ejected from the nozzles 36 toward the resilient blade 104 in sequence. Thus, the resilient blade 104 is moistened with the ink while wiping (sweeping). Here, after the resilient blade 104 passes the nozzles 36, the discharges of ink droplets are successively halted.

The nozzles 36 discharging the ink droplets discharge only at movement direction upstream side and downstream side vicinities of the resilient blade 104. In the present embodiment, ink is ejected only from the nozzles 36 that are within a range in which the ink will impact on the ink absorbers 106A and 106B. As a result, the interior of the inkjet recording device 12 (see FIG. 1) will not be soiled with ink. Further, as shown in FIG. 4B, ink Q, which is ejected at the resilient blade 104 and adheres to the resilient blade 104, flows along the resilient blade 104 and is absorbed at the ink absorber 106A.

In addition, a blade-cleaning member 39, which is formed of an ink absorber or the like, is provided at a movement direction downstream side end portion of the inkjet recording head 32. Accordingly, after the nozzle face 32A has been wiped (swept), the ink Q adhered to the resilient blade 104 is absorbed simply by the resilient blade 104 abutting against the blade-cleaning member 39.

As a result, the ink Q can be prevented from adhering to the resilient blade 104 for long periods, and deterioration of the resilient blade 104 due to the ink Q gradually soaking in can be prevented.

For the present embodiment, progressive distances of movement from a start point of movement of the wiping apparatus 100 are worked out beforehand, and the nozzles 36 that are to eject ink droplets are synchronized with the movement of the resilient blade 104.

If it is necessary to achieve more precise synchronization, movement amounts of the wiping apparatus 100 may be measured by measuring means to achieve synchronization between the resilient blade 104 and the nozzles 36 discharging the ink droplets. Measuring means (a measuring method) for measuring displacements of the wiping apparatus 100 could feature, for example, measurements using an encoder, or could measure displacements by monitoring numbers of turns of the screw shaft 114.

Next, operation of the present embodiment will be described.

In order to maintain continuously stable high printing quality, it is necessary for the inkjet recording head 32 to be stable in discharge characteristics of the ink droplets (for example, discharge directions of the ink droplets, ink droplet diameters, ink droplet speeds and the like).

However, when ink droplets are ejected from the nozzles 36, there is adhesion and the like to portions around the nozzles of a fine ink mist of satellite droplets and the like, and of foreign matter and suchlike. If, as a result, wetness of the portions around the nozzles 36 becomes uneven, the discharge characteristics of the ink droplets will become unstable. Accordingly, with a predetermined timing, the nozzle face 32A is wiped (swept) with the resilient blade 104, to clean the nozzle face 32A.

However, if a long time passes and ink that has adhered to the nozzle face 32A thickens/solidifies, it is not possible to remove the ink simply by wiping (sweeping) with the resilient blade 104, and wiping smears and ink residues will result.

Accordingly, as shown in FIGS. 3A to 3C, the resilient blade 104 wipes (sweeps) while ink droplets are being ejected from the nozzles 36 and the resilient blade 104 is being moistened with ink. Thus, wiping (sweeping) is performed while thickened/solidified ink is being liquefied. Therefore, the thickened/solidified ink can be thoroughly cleaned.

In the present embodiment, the sequential discharges of ink from the nozzles 36 and the sequential stopping of the discharges after the resilient blade 104 has passed may be controlled as follows.

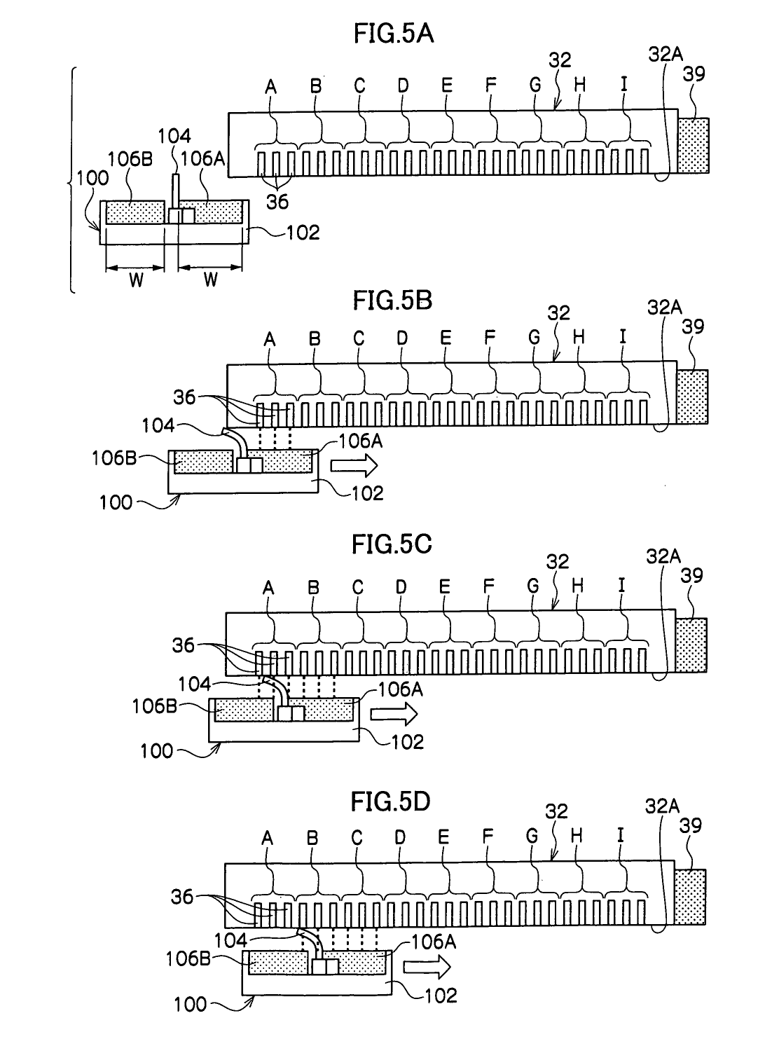

As shown in FIGS. 5A to 5D, the nozzles 36 are divided into nine blocks, from block A to block I. Herein, a width W of the ink absorbers 106A and 106B (see FIG. 5A) is broader than a width of each block but narrower than a width of two successive blocks. Furthermore, a width of three successive blocks is narrower than a spacing (width) between a downstream end of the ink absorber 106A at the downstream side and an upstream end of the ink absorber 106B at the upstream side.

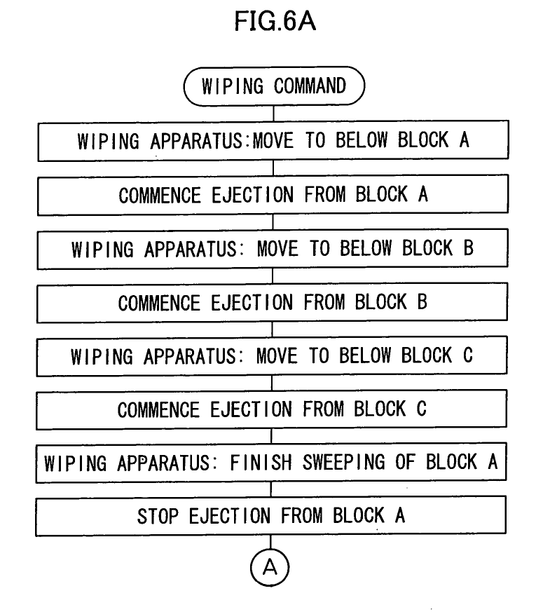

Anyway, as shown in the flowchart of FIGS. 6A and 6B, the wiping apparatus 100 moves and, when the upstream side block A wholly coincides with the ink absorber 106A, ink droplets are discharged from the nozzles 36 of block A (see FIG. 5B). Then, when the whole of block B coincides with the ink absorber 106A, ink droplets are discharged from the nozzles 36 of block B. Here, because the width of the two successive blocks A and B is narrower than the width W of the ink absorber 106A, the ink ejected from block A assuredly moistens the resilient blade 104 (see FIG. 5C). When the whole of block C coincides with the ink absorber 106A, ink droplets are discharged from the nozzles 36 of block C. Further, when block A moves out of opposition with the resilient blade 104, discharges of the nozzles 36 of block A are stopped (see FIG. 5D). Here, because the width of the three consecutive successive blocks A, B and C is narrower than the spacing (width) between the downstream end of the downstream side ink absorber 106A and the upstream end of the upstream side ink absorber 106B, ink will not impact outside of the wiping apparatus 100. Thus, in this manner, ink droplets are discharged from each block in succession, and the discharges are progressively stopped.

With a control process which controls discharges of ink droplets from each block in this manner, a number of objects of control can be made smaller than in a process which controls discharges of the nozzles 36 individually, and control is simpler.

Now, in the control process described above, blocks that are to eject ink are controlled by reference to pairs of blocks: block A; blocks A and B; blocks B and C; blocks C and D; . . . blocks H and I; and block I. However, the control process is not limited thus. It is also possible to control by reference to groups of three or more blocks, depending on the relationship between the wiping apparatus width and the block widths. For example, in a case of control by reference to triplets of blocks, the blocks that are to eject ink will be: block A; blocks A and B: blocks A, B and C, blocks B, C and D; . . . blocks G, H and I; blocks H and I; and block I.

With regard to the number of blocks, the nozzles are divided into nine blocks—block A to block I—in the above description, but this is not a limitation. There can be any number of blocks.

Further, although the ink absorber 106A and the ink absorber 106B have the same width W as one another (see FIG. 5A), widths thereof may be different.

Now, as shown in FIGS. 3A to 3C, when a distal end of the resilient blade 104 touches a nozzle 36A at the upstream-most side, the distal end of the resilient blade 104 is not yet thoroughly moistened.

Accordingly, pre-control may be performed, as described below.

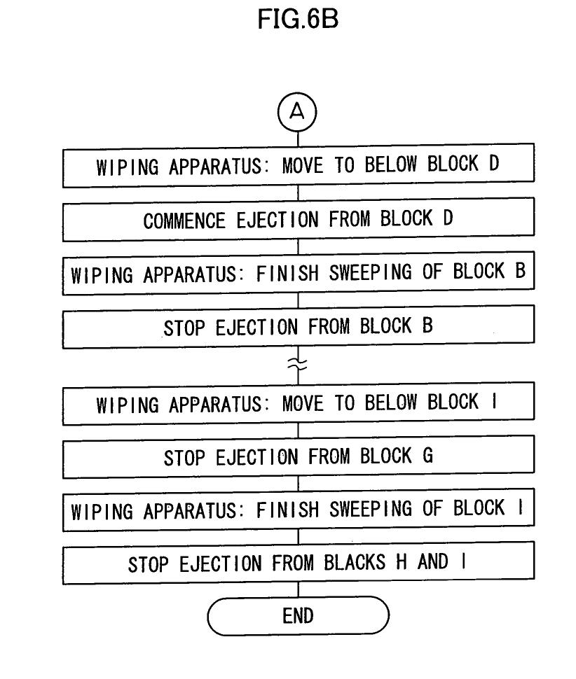

As shown in FIG. 7A, first, the inkjet recording head 32 is raised and the nozzle face 32A and the resilient blade 104 oppose each other in a separated state. In this state, ink droplets are ejected from the nozzles 36 to moisten the resilient blade 104.

Next, as shown in FIG. 7B, the wiping apparatus 100 is moved out of opposition with the inkjet recording head 32, and the inkjet recording head 32 is lowered.

Then, as shown in FIG. 7C, ink droplets are ejected from the nozzles 36 as described earlier, and the resilient blade 104 wipes (sweeps) while being moistened with ink.

Therefore, when the distal end of the resilient blade 104 touches the nozzle 36A at the upstream-most side, the distal end of the resilient blade 104 has already been thoroughly moistened, and thickened/solidified ink that has adhered in the vicinity of the nozzle 36A is thoroughly wetted and liquefied.

Further, after the wiping (sweeping) has been performed with the ink droplets being discharged from the nozzles 36 and the resilient blade 104 being moistened with the ink, there may be ink remaining at the nozzle face 32A.

Accordingly, post-control may be performed, as described below.

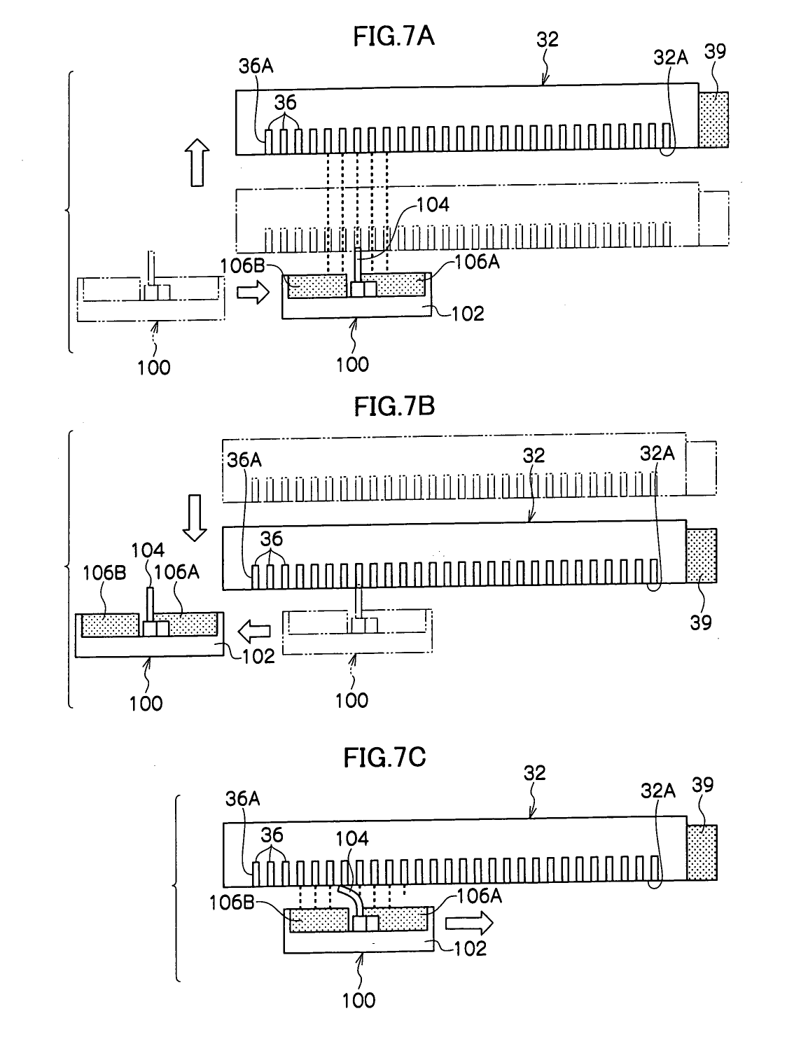

First, as shown in FIG. 8A, the wiping (sweeping) is performed with ink droplets being discharged from the nozzles 36 in the manner described above and the resilient blade 104 being moistened with the ink.

As shown in FIG. 8B, when the wiping (sweeping) is complete, the inkjet recording head 32 is raised and the inkjet recording head 32 and resilient blade 104 are separated. Then, the wiping apparatus 100 is moved back out of opposition with the inkjet recording head 32, and the inkjet recording head 32 is lowered.

Then, as shown in FIG. 8C, without ink droplets being discharged from the nozzles 36 this time, the wiping (sweeping) is performed without the resilient blade 104 being moistened with ink. In other words, dry-wiping is performed, to remove the ink remaining at the nozzle face 32A. Ink Q that is adhered to the resilient blade 104 subsequent to the dry-wiping is absorbed at the ink absorber 106A and the blade-cleaning member 39, as described earlier.

Here, rather than wiping (sweeping) after raising the inkjet recording head 32 and moving the wiping apparatus 100 out of opposition with the inkjet recording head 32 as shown in FIG. 8B, it is possible to wipe (sweep) by just moving the wiping apparatus 100 in the opposite direction to the first wipe with the resilient blade 104 not being moistened.

Next, a first variant example of the wiping apparatus will be described.

When the wiping apparatus 100 shown in FIG. 4A wipes (sweeps) as shown in FIG. 4B, the resilient blade 104 bends and, as shown in FIG. 4C, a gap may form between a root of the resilient blade 104 and the upstream side ink absorber 106A (see portion X in FIG. 4C). When this gap is formed, the ink Q flows to the root of the resilient blade 104, and accumulates rather than being absorbed by the ink absorber 106A. Hence, the accumulated ink remains adhered to the resilient blade 104 over a long period. As a result, the ink gradually soaks into the resilient blade 104, which may cause degradation of the resilient blade 104.

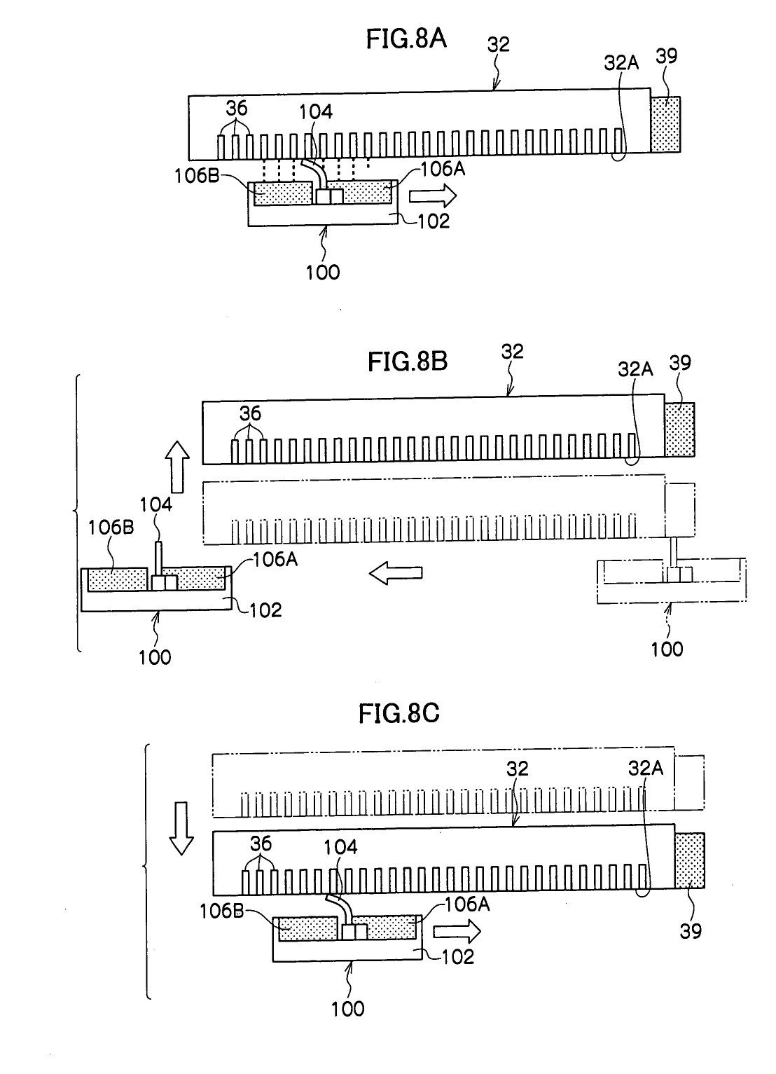

Accordingly, as shown in FIG. 9A, at a wiping apparatus 200 of the first variant example, a restraining portion 202 is provided at the movement direction upstream side of the resilient blade 104. The restraining portion 202 restrains a root portion of the resilient blade 104. Thus, as shown in FIG. 9B, even when the resilient blade 104 bends during wiping (sweeping), the downstream side ink absorber 106A and the resilient blade 104 are assuredly abutted together, and the ink Q is prevented from flowing to the root of the resilient blade 104 and accumulating thereat.

Next, a second variant example of the wiping apparatus will be described.

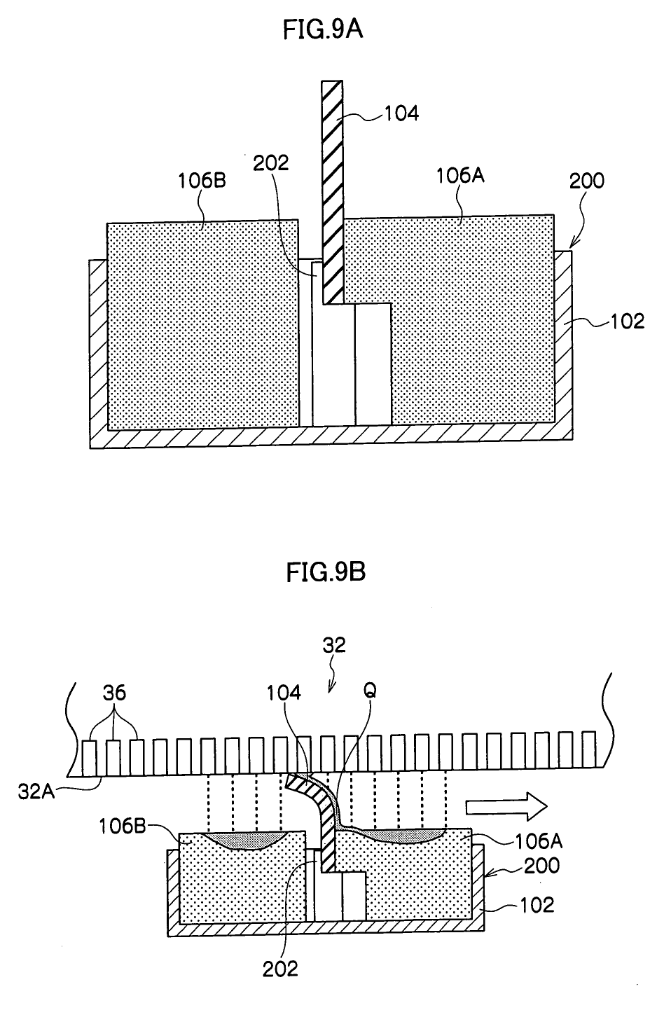

As shown in FIG. 10, at a wiping apparatus 300 of the second variant example, an ink displacement member 304 is provided at the movement direction upstream side of the resilient blade 104. In addition, a casing 302 has a structure from which the ink absorbers 106A and 106B (see FIGS. 4A to 4C) are absent, being replaced with a structure which retains ink in a container portion 308.

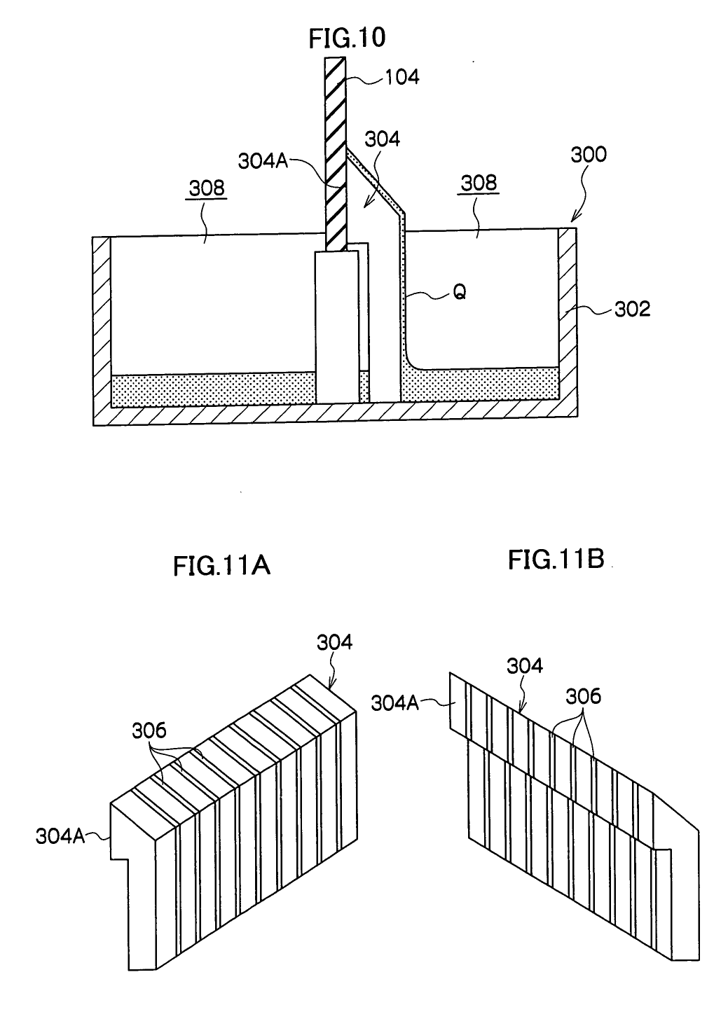

As shown in FIGS. 11A and 11B, in cross-section, an upper portion of the ink displacement member 304 has a substantially trapezoid shape and a lower portion has a substantially rectangular shape. Further, as shown in FIG. 10, one side 304A of the substantially trapezoid form touches the resilient blade 104.

As shown in FIGS. 11A and 11B, narrow grooves 306 are formed in a surface of the ink displacement member 304.

Hence, as shown in FIG. 10, ink Q that flows along the resilient blade 104 follows the grooves 306 of the ink displacement member 304 and flows to accumulate in the container portion 308.

Operational effects of the second variant example are similar to operational effects described for the first variant example.

Next, a third variant example of the wiping apparatus will be described.

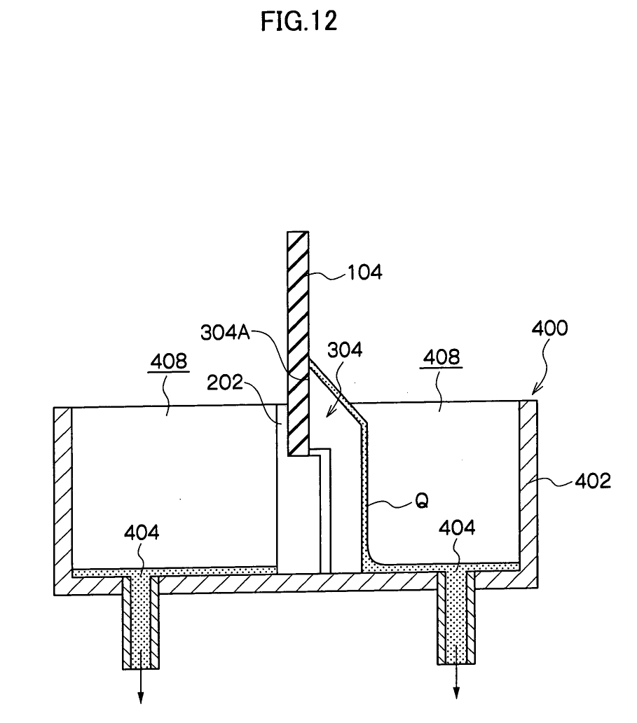

As shown in FIG. 12, at a wiping apparatus 400 of the third variant example, similarly to the second variant example, the ink displacement member 304 in which the grooves 306 are formed (see FIGS. 11A and 11B) is provided at the upstream side of the resilient blade 104. In addition, a casing 402 has a structure from which the ink absorbers 106A and 106B (see FIGS. 4A to 4C) are absent, being replaced with a structure which retains ink in a container portion 408.

Moreover, similarly to the first variant example, the restraining portion 202, which restrains the root portion of the resilient blade 104, is provided at the upstream side of the resilient blade 104. Thus, the one side 304A of the ink displacement member 304 and the resilient blade 104 are assuredly abutted together, and the ink Q is prevented from flowing to the root of the resilient blade 104 and accumulating thereat.

Furthermore, ink drainage ports 404 are formed in a bottom face of the container portion 408. The ink is drained through these ink drainage ports 404, using a suction pump or the like.

Operational effects of the third variant example combine similar operational effects to the first and second variant examples, and there is an advantage in that, because the ink retained in the container portion 408 is drained through the ink drainage ports 404 with a suction pump, a volume of the container portion 408 can be made smaller.

Next, a fourth variant example of the wiping apparatus will be described.

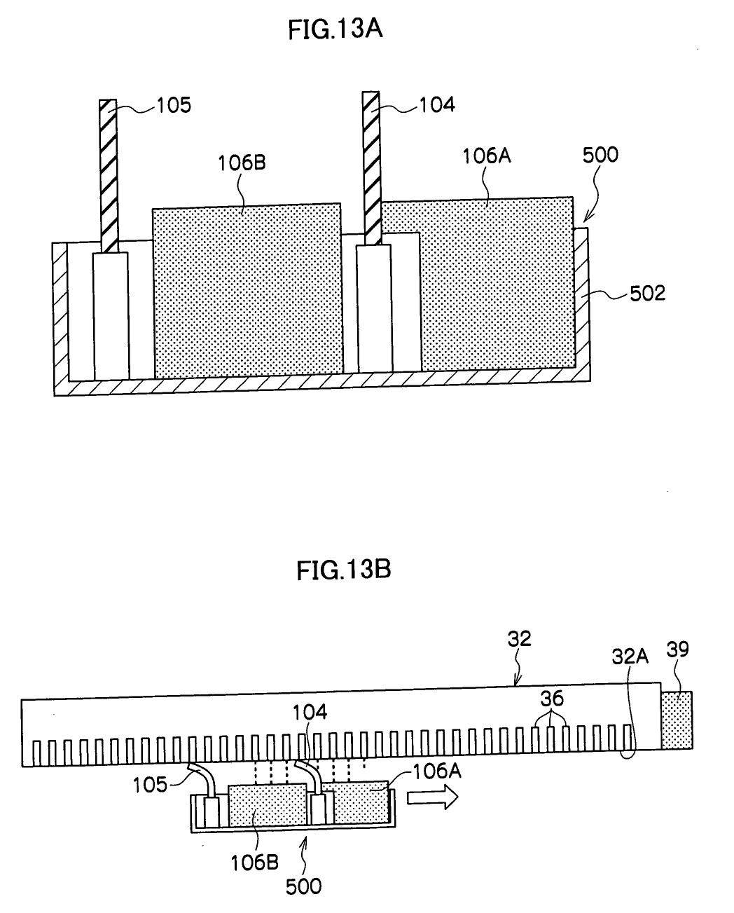

As shown in FIGS. 13A and 13B, at a wiping apparatus 500, a resilient blade for dry-wiping 105 is provided standing at an upstream side of the ink absorber 106A at the upstream side of the resilient blade 104. The resilient blade for dry-wiping 105 is similar in material and form to the resilient blade 104.

Hence, as shown in FIG. 13B, the control section (see FIG. 1) wipes (sweeps) the nozzle face 32A with ink droplets being ejected from the nozzles 36 toward the resilient blade 104 and moistening the resilient blade 104 with ink, but with ink droplets not being ejected toward the resilient blade for dry-wiping 105, and the resilient blade for dry-wiping 105 not being moistened with ink.

Therefore, similarly to the post-control described above, ink that remains after the wiping (sweeping) with the resilient blade 104 being moistened with ink is wiped (swept) and removed by the resilient blade for dry-wiping 105. Thus, it is possible to more thoroughly clean the nozzle face 32A. Moreover, because it is not necessary to perform the post-control, the operation of cleaning the nozzle face 32A can have a shorter duration.

Note that structures are also possible in which the resilient blade for dry-wiping 105 is provided at the wiping apparatus 200, 300 or 400 similar to the first to third variant examples.

The pre-control (pre-processing) described earlier (see FIGS. 7A to 7C) may also be performed. However, when the pre-processing is performed, only the resilient blade 104 is moistened with ink. Ink droplets are not discharged toward the resilient blade for dry-wiping 105, and the resilient blade for dry-wiping 105 is not moistened with ink.

Next, an inkjet recording device of a second embodiment will be described. Note that members that are the same as in the first embodiment are assigned the same reference numerals, and duplicative descriptions are omitted.

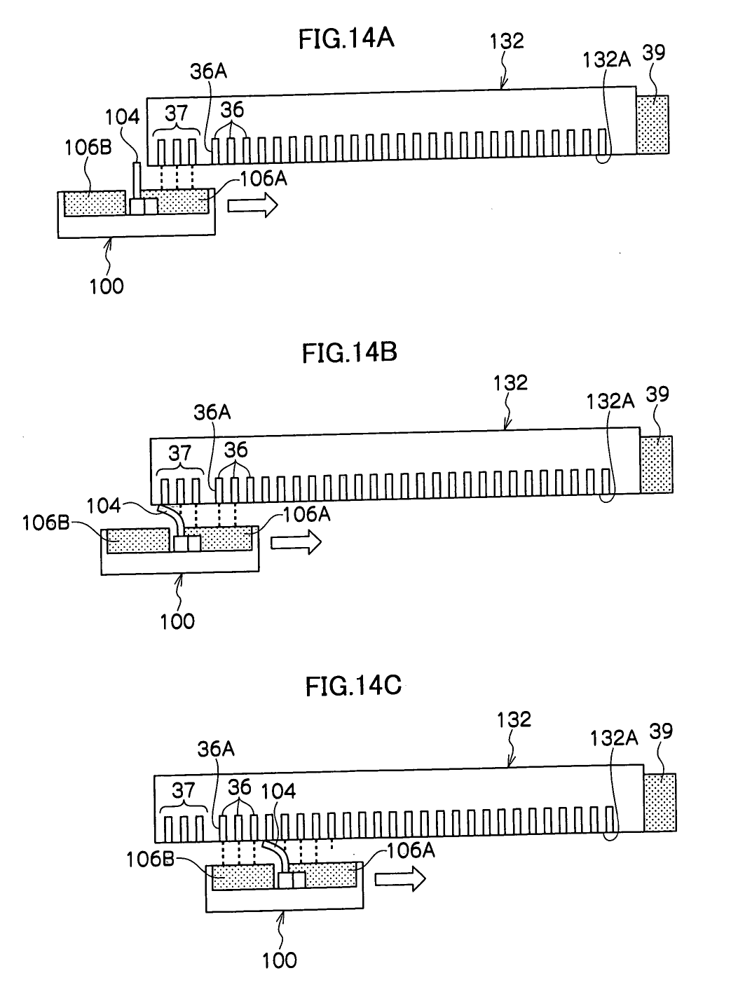

As shown in FIGS. 14A to 14C, an inkjet recording head 132 of the inkjet device of the second embodiment is provided with a plurality of cleaning nozzles 37 at an upstream side end portion of a nozzle face 132A with respect to the direction of movement of the wiping apparatus 100 (a side further upstream than an upstream-most side nozzle 36A). Ink droplets are discharged from these cleaning nozzles 37 in a similar manner to the ordinary nozzles 36. However, the cleaning nozzles 37 do not contribute to image formation. The control section 11 (see FIG. 1) performs control for discharges of ink droplets from these cleaning nozzles 37.

Next, operation of the present embodiment will be described.

As shown in FIGS. 14A to 14C, when the resilient blade 104 is abutted and the resilient blade 104 is to be moved along the nozzle face 132A for wiping (sweeping), initially, the resilient blade 104 is moistened with ink droplets discharged from the cleaning nozzles 37, as shown in FIG. 14B. Thereafter, the ordinary nozzles 36 are wiped (swept).

Consequently, similarly to the operational effect of the pre-control described for the first embodiment, when the distal end of the resilient blade 104 touches the nozzle 36A at the upstream-most side, the distal end of the resilient blade 104 is already thoroughly moistened with ink. Therefore, thickened/solidified ink adhering in a vicinity of the nozzle 36A is thoroughly wetted and liquefied. Furthermore, because it is not necessary to perform the pre-control described for the first embodiment, cleaning operations can be finished in a shorter time.

Note that the post-control (post-processing) described for the first embodiment may also be performed. Moreover, the present embodiment may be provided with the wiping apparatuses 200, 300, 400 and 500 of the first to fourth variant examples of the first embodiment. In a case in which the wiping apparatus 500 of the fourth variant example (see FIGS. 13A and 13B) is provided, post-control is not required. Moreover, ink droplets are not ejected from the cleaning nozzles 37 toward the resilient blade for dry-wiping 105 (see FIGS. 13A and 13B), and the resilient blade for dry-wiping 105 is not moistened with ink.

The present invention is not limited to the embodiments described above.

For example, in the embodiments described above, the inkjet recording head 32 or 132 is lifted upward to separate the nozzle face 32A or 132A of the inkjet recording head 32 or 132 from the resilient blade 104. However, it is possible for the wiping apparatus to be lowered for separation, and it is possible for the inkjet recording head and the wiping apparatus to both move, respectively, up and down.

Further, as an example, the embodiments described above have “full width arrays” (FWA) corresponding to paper widths. However, this is not a limitation.

A partial width array (PWA) is also possible: while an inkjet recording head moves in a main scanning direction, ink droplets are selectively discharged from the nozzles to record a portion of an image on a predetermined band region in accordance with image data. Then, when one cycle of movement in the main scanning direction has finished, recording paper P is conveyed in a sub-scanning direction by a predetermined pitch and, while the inkjet recording head is again moving in the main scanning direction, a portion of the image is recorded on the next band region in accordance with the image data.

Further, in a case with such a PWA, a structure is also possible in which, for the operation of moving the resilient blade along the nozzle face and wiping (sweeping), the resilient blade (i.e., the wiping apparatus) is fixed rather than moving, and the inkjet recording head moves. Alternatively, both of the inkjet recording head and the resilient blade (the wiping apparatus) could move.

Further, inkjet recording of the present invention is not limited to recording of texts, images and the like on recording paper P. That is, the recording medium is not limited to paper, and the liquid to be ejected is not limited to ink. It is possible to apply the present invention to the generality of liquid droplet ejection apparatuses which are used in industry, such as, for example, ejecting ink onto a polymer film or glass to fabricate a color filter for a display, ejecting molten solder onto a substrate to form bumps for component mounting, and the like.

What is claimed is:

1. An inkjet recording device comprising:
an inkjet recording head, which ejects ink droplets from a plurality of nozzles formed in a nozzle face;
a first wiper, which abuts against the nozzle face and wipes the nozzle face;
a first movement component, which relatively, with respect to the nozzle face, moves the first wiper along the nozzle face; and
a control component, which controls ejection of ink droplets from the nozzles and controls the first movement component,
wherein the control component moves the first wiper relative to the nozzle face while the control component causes ink droplets to be ejected from the nozzles toward at least the first wiper.

2. The inkjet recording device of claim 1, wherein the control component causes the nozzle face to be wiped while the control component causes ink droplets to be ejected from the nozzles toward at least the first wiper, and subsequently causes the nozzle face to be wiped without ink droplets being ejected from the nozzles.

3. The inkjet recording device of claim 1, further comprising a second wiper, which is provided separately from the first wiper at an upstream side, with respect to a movement direction, relative to the first wiper, the second wiper relatively moving integrally with the first wiper along the nozzle face, and the second wiper abutting against the nozzle face and wiping the nozzle face,
wherein the control component causes ink droplets to be ejected from the nozzles toward at least the first wiper while the control component causes ink droplets to not be ejected toward the second wiper.

4. The inkjet recording device of claim 1, wherein
the inkjet recording head includes a cleaning nozzle, at an end portion of the nozzle face which is at an upstream side thereof with respect to a movement direction,
the control component controls ejection of ink droplets from the cleaning nozzle, and
the control component causes ink droplets to be ejected from the cleaning nozzle toward the first wiper, and subsequently causes the nozzle face to be wiped while ink droplets are ejected from the nozzles toward at least the first wiper.

5. The inkjet recording device of claim 1, wherein
the first movement component further relatively moves the first wiper and the nozzle face between a mutually abutting state and a separated state, and
the control component causes the first wiper to be separated from and oppose the nozzle face and causes ink droplets to be ejected from the nozzles toward at least the first wiper, and subsequently causes the nozzle face to be wiped while ink droplets are ejected from the nozzles toward at least the first wiper.

6. The inkjet recording device of claim 1, further comprising an ink-receiving portion at an upstream side and a downstream side of the first wiper, with respect to a movement direction, the ink-receiving portion moving integrally with the first wiper.

7. The inkjet recording device of claim 2, wherein
the inkjet recording head includes a cleaning nozzle, at an end portion of the nozzle face which is at an upstream side thereof with respect to a movement direction,
the control component controls ejection of ink droplets from the cleaning nozzle, and
the control component causes ink droplets to be ejected from the cleaning nozzle toward the first wiper, and subsequently causes the nozzle face to be wiped while ink droplets are ejected from the nozzles toward at least the first wiper.

8. The inkjet recording device of claim 3, wherein
the inkjet recording head includes a cleaning nozzle, at an end portion of the nozzle face which is at an upstream side thereof with respect to a movement direction,
the control component controls ejection of ink droplets from the cleaning nozzle, and
the control component causes ink droplets to be ejected from the cleaning nozzle toward the first wiper, and subsequently causes the nozzle face to be wiped while ink droplets are ejected from the nozzles toward at least the first wiper.

9. The inkjet recording device of claim 2, wherein
the first movement component further relatively moves the first wiper and the nozzle face between a mutually abutting state and a separated state, and
the control component causes the first wiper to be separated from and oppose the nozzle face and causes ink droplets to be ejected from the nozzles toward at least the first wiper, and subsequently causes the nozzle face to be wiped while ink droplets are ejected from the nozzles toward at least the first wiper.

10. The inkjet recording device of claim 3, wherein
the first movement component further relatively moves the first wiper and the nozzle face between a mutually abutting state and a separated state, and
the control component causes the first wiper to be separated from and oppose the nozzle face and causes ink droplets to be ejected from the nozzles toward at least the first wiper, and subsequently causes the nozzle face to be wiped while ink droplets are ejected from the nozzles toward at least the first wiper.

11. The inkjet recording device of claim 2, further comprising an ink-receiving portion at an upstream side and a downstream side of the first wiper, with respect to a movement direction, the ink-receiving portion moving integrally with the first wiper.

12. The inkjet recording device of claim 3, further comprising an ink-receiving portion at an upstream side and a downstream side of the first wiper, with respect to a movement direction, the ink-receiving portion moving integrally with the first wiper.

13. The inkjet recording device of claim 4, further comprising an ink-receiving portion at an upstream side and a downstream side of the first wiper, with respect to a movement direction, the ink-receiving portion moving integrally with the first wiper.

14. The inkjet recording device of claim 5, further comprising an ink-receiving portion at an upstream side and a downstream side of the first wiper, with respect to a movement direction, the ink-receiving portion moving integrally with the first wiper.

15. A method for cleaning a nozzle face of an inkjet recording head of an inkjet recording device, the inkjet recording device including
an inkjet recording head, which ejects ink droplets from a plurality of nozzles formed in a nozzle face,
a wiper, which abuts against the nozzle face and wipes the nozzle face, and
a first movement component, which relatively, with respect to the nozzle face, moves the first wiper along the nozzle face,
wherein the cleaning method comprises a step of cleaning, which includes:
ejecting ink droplets from the nozzles toward at least the wiper;
during ejecting the ink droplets, moving the wiper relative to the nozzle face.

16. The cleaning method of claim 15, further comprising, after the step of cleaning, a post-processing step of wiping the nozzle face with the wiper without ejecting ink droplets from the nozzles.

17. The cleaning method of claim 15, wherein the first movement component further relatively moves the wiper and the nozzle face between a mutually abutting state and a separated state,
and the cleaning method further includes, before the step of cleaning, a pre-processing step of ejecting ink droplets toward at least the wiper in a state in which the wiper and the nozzle face are separated and mutually opposing.
